(19) United States
(12) Patent Application Publication
(10) Pub. No.: US 2009/0184110 A1
(43) Pub. Date: Jul. 23, 2009

(54) HEATING APPARATUS AND FURNITURE AND WALL MEMBER INCORPORATING HEATING APPARATUS

(75) Inventors: Yoshio Semori, Nara (JP); Masato Youta, Nara (JP); Tomokazu Itou, Nara (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/300,932

(22) PCT Filed: May 14, 2007
(86) PCT No.: PCT/JP2007/059893

§ 371 Date: Jan. 21, 2009

(30) Foreign Application Priority Data
May 16, 2006 (JP) 2006-136154
Apr. 2, 2007 (JP) 2007-096247

(51) Int. Cl. H05B 6/64

(52) U.S. Cl. 219/702; 219/758; 219/757

(57) ABSTRACT

To provide a heating apparatus which is good in the matching property when incorporated into a cabinet etc. without degrading the usability of a heating apparatus itself.

The heating apparatus is configured by a lid 4 which opens and closes a heating chamber 3, a control portion 5 which controls a heating unit and an operation portion 6 which controls the driving of the heating unit. The operation portion 6 is configured by being provided with electrostatic switches at the inner side of a semi-transparent member and is also configured in a manner that the operation portion is illuminated and placed in a state of accepting a switch operation when the semi-transparent member is touched. The operation portion normally cannot be seen from the outside and so the apparatus is good in the matching property with furniture etc. when incorporated into a cabinet etc. Further, when a user touches the semi-transparent member at the time of service, the operation portion is illuminated and placed in the state of accepting the switch operation. Thus, the apparatus can be used in the similar manner as the conventional apparatuses without degrading usablity.

### TECHNICAL FIELD

The present invention relates to a heating apparatus for heating material to be heated by using a heater or microwave etc and, in particular, relates to a heating apparatus suitable when used by being incorporated into a cabinet etc., and furniture and a wall member incorporating the heating apparatus therein.

### BACKGROUND ART

In general, a heating apparatus for heating material to be heated by using a heater or microwave etc., for example, a high-frequency heating apparatus is provided with an operation portion for a heating unit etc. on the surface of the main body of the apparatus (see a patent document 1,for example).

FIG. 8 shows such a high-frequency heating apparatus which is provided with a lid 53 for opening and closing a heating chamber 52 and an operation portion 54 for operating a heating unit (not shown) on the front face of the main body of the apparatus, whereby various kinds of cooking are made by operating the operation portion 54.

### Patent Document 1: JP-A-10-132285

### DISCLOSURE OF THE INVENTION

Problems that the Invention is to Solve

However, the heating apparatus of the prior art is placed in a state that the operation portion 54 can be always seen for the outside. Thus, although there arises no problem in the case of using the heating apparatus independently, there arises a problem that, when used by being incorporating into a cabinet etc., the matching property of the apparatus with the furniture in which the apparatus is incorporated is bad.

The invention obviates such a problem and an object of the invention is to provide a heating apparatus which is good in the matching property when incorporated into a cabinet etc. without degrading the usability of the apparatus itself.

### Means for Solving the Problems

In order to attain the aforesaid object, the invention is configured to include a heating chamber; a heating unit which heats a material to be heated within the heating chamber; a lid which opens and closes the heating chamber: a control portion which controls the heating unit; and an operation portion which controls driving of the hating unit, wherein the operation portion is configured by being provided with an electrostatic switch at an inner side of a semi-transparent member and is configured to emit light and be placed in a state of accepting a switch operation when the semitransparent member is touched.

Thus, normally the operation portion cannot be seen from the outside and the matching with furniture etc. is good in the case of being incorporated into a cabinet etc. Further, when a user uses the apparatus, since the operation portion emits light and is placed in the state of accepting the switch operation, the apparatus can be used in a similar manner as the conventional apparatuses without degrading usability.

### EFFECTS OF THE INVENTION

According to the invention, normally the operation portion cannot be seen but the operation portion can be seen and is operable like the conventional apparatuses at the time of service. Thus, without degrading the usability, the external appearance of the apparatus can be made neat not only in the case of using the apparatus itself but also in the case of using the apparatus by incorporating within a cabinet etc., and the matching with furniture is good in the case of not using the apparatus.

### BRIEF DESCRIPTION OF THE DRAWINGS

FIG. 1 is a perspective view of a state where a heating apparatus according the first embodiment of the invention is incorporated into a cabinet.

FIG. 2 is a perspective view in a case where the lid of the heating apparatus is opened.

FIG. 3 is a front view showing a state where the operation portion of the heating apparatus emits light.

FIG. 4 is an perspective view of dismantled parts of the operation portion of the heating apparatus.

FIG. 5 is a sectional view of the operation portion of the heating apparatus.

FIG. 6A is a perspective view of a heating apparatus according to another embodiment and FIG. 6B is a sectional view thereof.

FIG. 7A is a perspective view of a heating apparatus according to a still another embodiment and FIG. 7B is a sectional view thereof.

FIG. 8 is a perspective view showing a heating apparatus of the prior art.

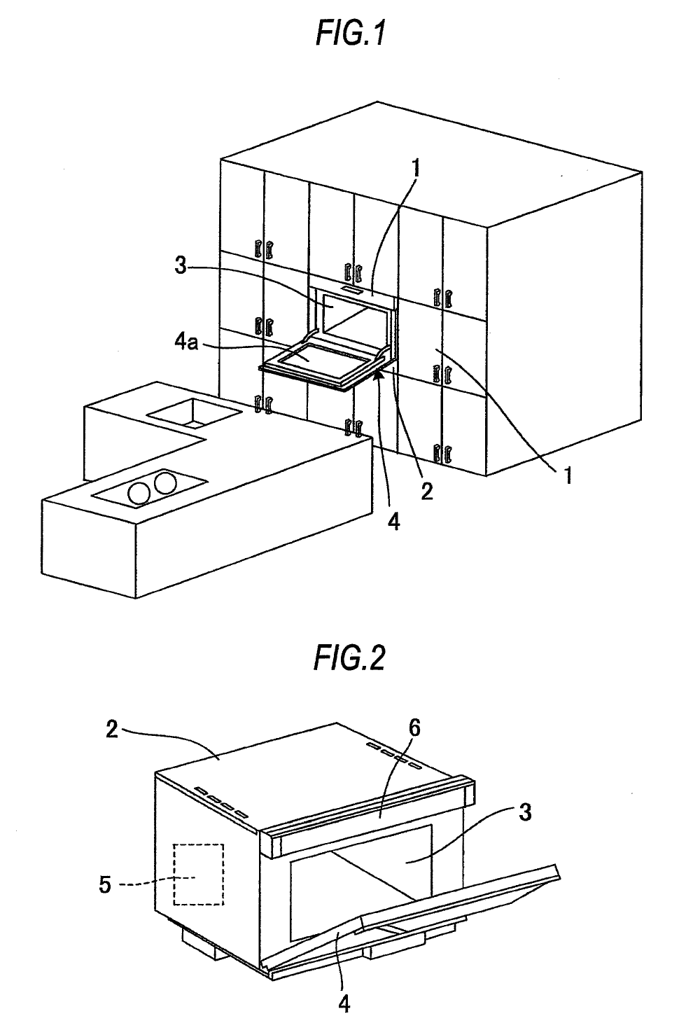

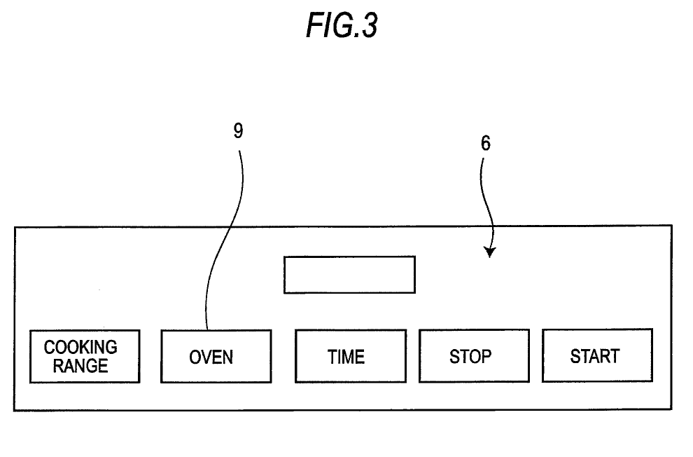

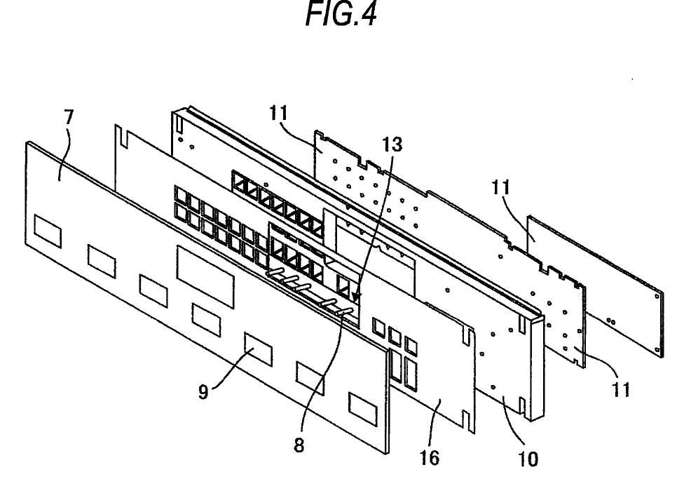

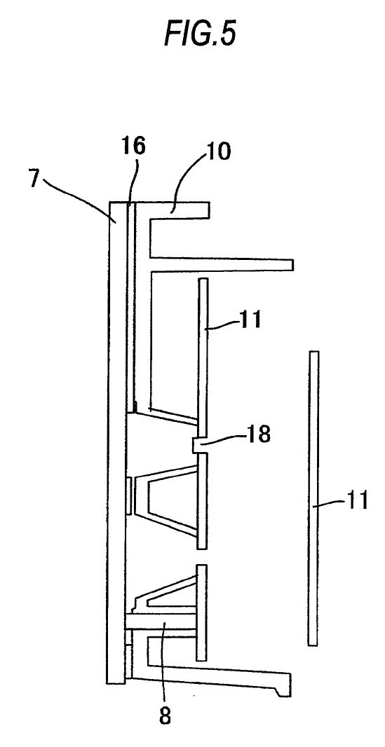

### EXPLANATION OF SIGNS

1 cabinet
2 heating apparatus
3 heating chamber
4 lid
4a window
5 control portion
6 operation portion
7 semi-transparent member
8 electrostatic switch
9 switch operation display portion
18 light emission unit

### BEST MODE FOR CARRYING OUT THE INVENTION

The first invention is configured to include a heating chamber; a heating unit which heats a material to be heated within the heating chamber; a lid which opens and closes the heating chamber: a control portion which controls the heating unit; and an operation portion which controls driving of the heating unit, wherein the operation portion is configured by being provided with an electrostatic switch at the inner side of a semi-transparent member and is configured to emit light and be placed in a state of accepting a switch operation when the semi-transparent member is touched. Thus, normally the operation portion cannot be seen from the outside and the matching with furniture etc. is good when being incorporated into a cabinet etc. Further, when a user touches the semi-transparent member at the time of service, the operation portion emits light and is placed in the state of accepting the switch operation, whereby the apparatus can be used in a similar manner as the conventional apparatuses without degrading usability.

The second invention is configured in a manner that the semi-transparent member is provided with a plurality of switch operation display portions, the switch operation display portion emits light and the electrostatic switch is placed in an accepting state when the switch operation display portion is touched, and the control is started when the switch operation display portion is touched. Thus, the switch operation display portion serves as an operation switch for illuminating the switch operation display portion and also serves as a switch for transmitting a control signal to the control portion, whereby the configuration can be simplified.

The third invention is configured to include a heating chamber; a heating unit which heats a material to be heated within the heating chamber; a lid which opens and closes the heating chamber: a control portion which controls the heating unit; and an operation portion which controls driving of the heating unit, wherein the operation portion is configured by being provided with an electrostatic switch at the inner side of a semi-transparent member and is configured to emit light and be placed in a state of accepting a switch operation when the lid is opened. Thus, normally the operation portion cannot be seen from the outside and the matching with furniture etc. is good when being incorporated into a cabinet etc. Further, when a user opens the lid at the time of service, the operation portion emits light and is placed in the state of accepting the switch operation, whereby the apparatus can be used in a similar manner as the conventional apparatuses without degrading usability. Furthermore, since the operation portion is not placed in the state of accepting the switch operation so long as the lid is not opened, such an erroneous operation can be prevented from occurring that the operation portion is erroneously touched and so the heating operation starts.

The fourth invention is configured to include a heating chamber; a heating unit which heats a material to be heated within the heating chamber; a lid which opens and closes the heating chamber; a control portion which controls the heating unit; an operation portion which controls driving of the heating unit; and a human body detecting device, wherein

the operation portion is configured by being provided with an electrostatic switch at the inner side of a semi-transparent member and is configured to emit light and be placed in a state of accepting a switch operation when the human body detecting device detects a human body.

Thus, normally the operation portion cannot be seen from the outside and the matching with furniture etc. is good when being incorporated into a cabinet etc. Further, when a user approaches the apparatus main body in order to use the apparatus, the approach is detected and so the operation portion automatically emits light and is placed in the state of accepting the switch operation, whereby the apparatus can be used in a similar manner as the conventional apparatuses without degrading usability. Furthermore, since it is not necessary to perform such an operation of touching the operation portion, the usability is good.

The fifth invention is configured in a manner that, in one of the aforesaid first to fourth inventions, the lid is provided with a window portion through which the inner portion of the heating chamber can be seen, and the operation portion and the window portion are provided on the substantially same plane. Thus, the lid and the operation portion can be recognized as integral configuration and so the matching with furniture can be further facilitated when incorporated into the furniture etc.

The sixth invention is configured in a manner that, in one of the aforesaid first to fifth inventions, the semi-transparent member of each of the window portion of the lid and the operation portion is configured by a semi-transparent mirror. Thus, the matching with furniture can be further facilitated when incorporated into the furniture etc.

The seventh invention is a cabinet in which the heating apparatus according to one of the aforesaid first to sixth inventions is incorporated. The eighth invention is a wall member in which the heating apparatus according to one of the aforesaid first to sixth inventions is incorporated.

Hereinafter, an embodiment of the invention will be explained with reference to drawings. The invention is not limited to the embodiment.

### FIRST EMBODIMENT

In the figure, a symbol 1 depicts a cabinet, and a symbol 2 depicts a heating apparatus in which the cabinet 1 is incorporated therein and in which a heating chamber 3 for heating material to be heated by a heating unit (not shown) such as a heater, a high-frequency or steam is provided. A symbol 4 depicts a lid for opening and closing the heating chamber 3. The lid is configured by providing a window portion 4a within a metal frame and the window portion 4a is configured by subjecting a heat-resisting glass to the smoke processing. A symbol 5 depicts a control portion for controlling the heating unit and the control portion is provided at a suitable portion of the main body of the apparatus. A symbol 6 depicts an operating portion provided at the upper portion of the lid of the apparatus main body and the operation portion controls the heating unit etc. via the control portion 5.

The operation portion 6 is configured to be provided with electrostatic switches 8 at the inner side of a semi-transparent member 7 and further configured to emit light and be placed in a state of accepting the switch operation when the switch operation display portions 9 of the semi-transparent member 7 are touched. That is, a symbol 10 depicts an operation portion frame, and a symbol 11 depicts a printed board which is provided within the operation portion frame 10 and is provided with control parts and the electrostatic switch 8 for instructing various kinds of controls to the control portion 5. The electrostatic switches 8 are provided so as to face on the front surface via an opening 13 provided at the operation portion frame 10. The semi-transparent member 7 is attached on the front face of the operation portion frame 10 via an adhering member 16 such as a double-stick tape so as to cover the front face of the electrostatic switches 8. The member is configured by a semi-transparent mirror subjected to the smoke processing. A symbol 9 depicts the switch operation display portions formed at the semi-transparent member 7 in correspondence with the electrostatic switches 8, respectively. The control portion 5 is configured in a manner that, when a user touches the switch operation display switch operation display portion 9, all the switch operation display portions 9 are illuminated so that the switch operation display portions can be seen from the outside and is placed in the state of accepting the switch operation. A symbol 18 depicts a light emission unit such as an LED which illuminates the switch operation display portions 9 so that the switch operation display portions can be seen from the outside.

Thus, the operation portion 6 of the heating apparatus is arranged in a manner that normally the switch operation display portions 9 cannot be seen from the outside at all and the switch operation display portions 9 can be seen from the outside at the time when a user touches the switch operation display portion 9 to illuminate the light emission means 18 corresponding thereto.

As clear from the aforesaid configuration, according to the heating apparatus, since the switch operation display portions 9 cannot be seen from the outside at all normally, the heating apparatus matches with the cabinet to such a degree as if the heating apparatus is a part of the cabinet 1.

When a user touches at least one of the switch operation display portion 9, the light emission unit 18 respectively corresponding to the switch operation display portions 9 are illuminated; whereby the switch operation display portions 9 appear at the operation portion 6 and each of the switch operation display portions 9 is placed in the state of accepting the switch operation. Thus, when a user touches the necessary switch operation display portion 9 so as to perform a desired cooking, a corresponding switch operation signal is transmitted to the potion 5 to perform the control allocated to this switch operation display portion 9.

According to the embodiment, since the switch operation display portions 9 serve not only as a switch for illuminating the switch operation display portions 9 but also as a switch for placing into the state of accepting the switching operations of the electrostatic switches B corresponding to the switch operation display portions 9, respectively, that is, for making it possible to transmit a signal from the electrostatic switch 8 to the control portion 5, the apparatus of simplified configuration and low cost can be provided.

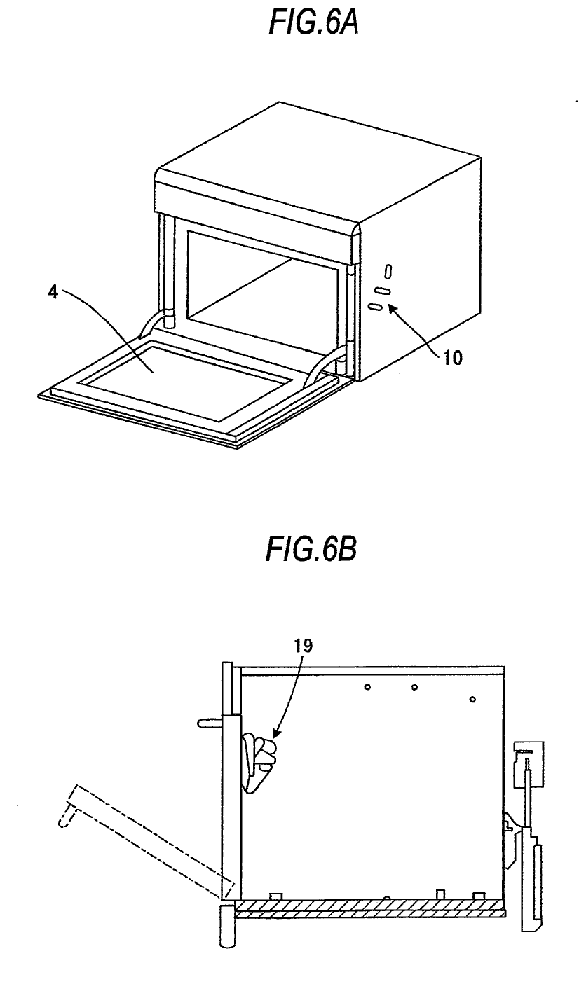

Further, as shown in FIGS. 6A and 6B, according to the embodiment, an exhaust fan 22 for discharging hot air within the heating chamber 3 is incorporated within the apparatus main body. The air sent from the exhaust fan 22 cools within the apparatus main body and the hot air is exhausted, via an exhaust duct 23 provided at the outer side portion of the heating chamber ,from an exhaust port 24 provided between the lid 4 and a front panel 6 in which the operation portion of the apparatus main body is incorporated. The exhaust port 24 is provided between the lid 4 and the front panel 6 and is formed like a single line so as to be simple in the external appearance.

### SECOND EMBODIMENT

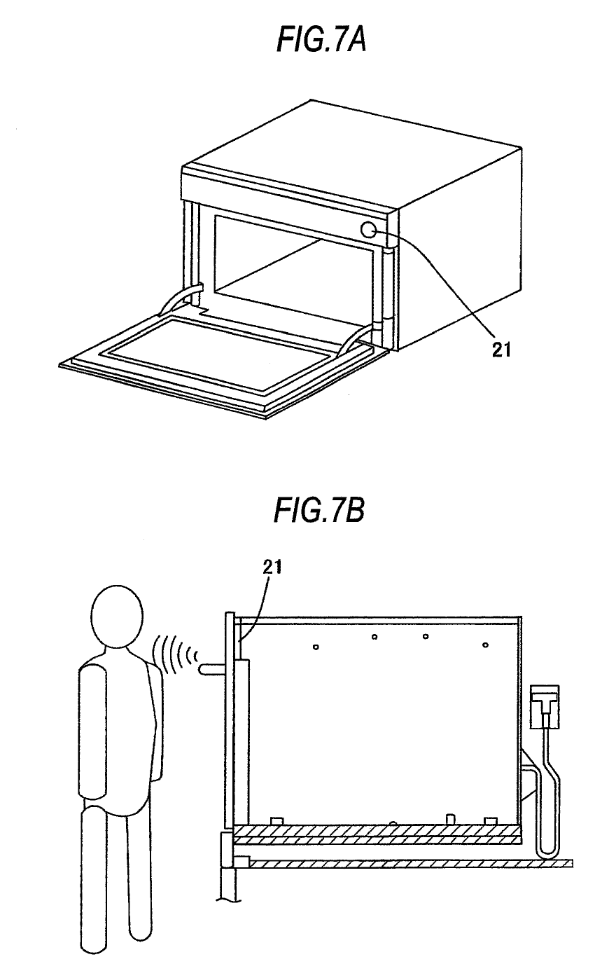

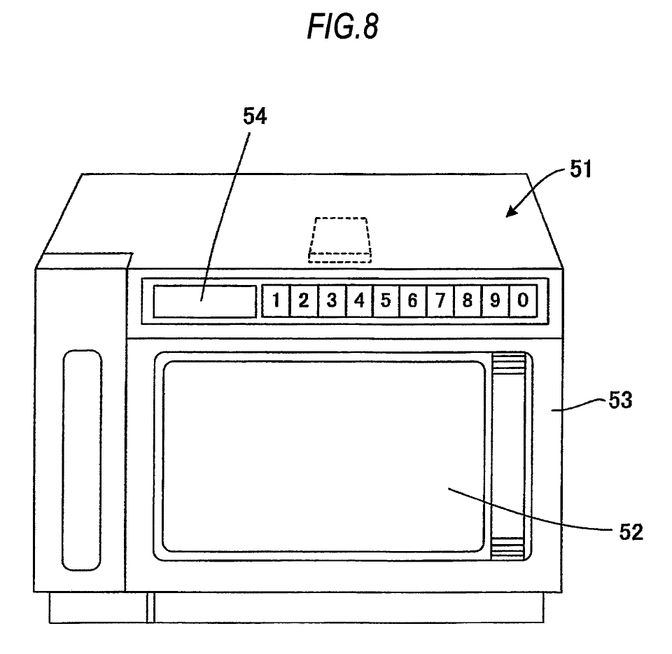

The first embodiment is configured in a manner that the switch operation display portions 9 can be seen and is placed in the state capable of performing the switch operation when the switch operation display portion 9 of the operation portion 6 is touched. However, as shown in FIGS. 7A and 7B, such an operation may be performed by a switch 19 operated in response to the opening of the lid 4 or a touch switch provided at a lid handle. Alternatively, as shown in FIG. 8, such an operation may be performed when a human body detecting device 21 such as an infrared ray sensor incorporated at a suitable portion of the apparatus main body detects a human body.

The present application is based on Japanese Patent Application (Japanese Patent Application No. 2006-136154) filed on May 16, 2006 and Japanese Patent Application (Japanese Patent Application No. 2007-96247) filed on Apr. 2, 2007, the contents of which are incorporated herein by reference.

### INDUSTRIAL APPLICABILITY

According to the invention, the operation portion normally cannot be seen but can be seen and is operable at the time of using like the prior art. Thus, without degrading the usability, the external appearance of the apparatus can be made simple not only in the case of using the apparatus itself but also in the case of using the apparatus by incorporating within a cabinet etc., and the matching with furniture is good in the case of not using the apparatus.

1. A heating apparatus comprising:
a heating chamber;
a heating unit which heats a material to be heated within the heating chamber;
a lid which opens and closes the heating chamber;
a control portion which controls the heating unit; and
an operation portion which controls driving of the heating unit, wherein the operation portion is configured by being provided with an electrostatic switch at an inner side of a semi-transparent member and is configured to emit light and be placed in a state of accepting a switch operation when the semi-transparent member is touched.

2. A heating apparatus according to claim 1, wherein the lid is openably and closably disposed at a front face of a main body of the apparatus constituting the heating chamber, an upper portion of a front face of the heating chamber of the apparatus main body is covered by a front panel constituted by a semi-transparent member like the lid, and the operation portion is provided at the front panel.

3. A heating apparatus according to claim 2, wherein the apparatus main body is provided with an exhaust fan and an exhaust port for discharging hot air within the heating chamber, and the exhaust port is opened between the lid and the front panel.

4. A heating apparatus according to claim 1, wherein the semi-transparent member is provided with a plurality of switch operation display portions, the switch operation display portion emits light and the electrostatic switch is placed in an accepting state when the switch operation display portion is touched, and the control is started when the switch operation display portion is touched.

5. A heating apparatus comprising:
a heating chamber;
a heating unit which heats a material to be heated within the heating chamber;
a lid which opens and closes the heating chamber:
a control portion which controls the heating unit; and
an operation portion which controls driving of the heating unit, wherein the operation portion is configured by being provided with an electrostatic switch at an inner side of a semi-transparent member and is configured to emit light and be placed in a state of accepting a switch operation when the lid is opened or a handle of the lid is touched.

6. A heating apparatus comprising:
a heating chamber;
a heating unit which heats a material to be heated within the heating chamber;
a lid which opens and closes the heating chamber;
a control portion which controls the heating unit;
an operation portion which controls driving of the heating unit; and
a human body detecting device, wherein the operation portion is configured by being provided with an electrostatic switch at an inner side of a semi-transparent member and is configured to emit light and be placed in a state of accepting a switch operation when the human body detecting device detects a human body.

7. A heating apparatus according to claim 1, wherein the lid is provided with a window portion through which an inner portion of the heating chamber can be seen, and the operation portion and the window portion are provided on a substantially same plane.

8. A heating apparatus according to claim 1, wherein the semi-transparent member of each of the window portion of the lid and the operation portion is configured by a semi-transparent mirror.

9. A cabinet in which the heating apparatus according to claim 1 is incorporated.

10. A wall member in which the heating apparatus cording to claim 1 is incorporated.

11. A heating apparatus according to claim 5, wherein the lid is provided with a window portion through which an inner portion of the heating chamber can be seen, and the operation portion and the window portion are provided on a substantially same plane.

12. A heating apparatus according to claim 5 wherein the semi-transparent member of each of the window portion of the lid and the operation portion is configured by a semi-transparent mirror.

13. A cabinet in which the heating apparatus according to claim 5 is incorporated.

14. A wall member in which the heating apparatus according to claim 5 is incorporated.

15. A heating apparatus according to claim 6 wherein the lid is provided with a window portion through which an inner portion of the heating chamber can be seen, and the operation portion and the window portion are provided on a substantially same plane.

16. A heating apparatus according to claim 6 wherein the semi-transparent member of each of the window portion of the lid and the operation portion is configured by a semi-transparent mirror.

17. A cabinet in which the heating apparatus according to claim 6 is incorporated.

18. A wall member in which the heating apparatus according to claim 6 is incorporated.
